(19) United States
(12) Patent Application Publication
(10) Pub. No.: US 2018/0252204 A1
(43) Pub. Date: Sep. 6, 2018

(54) WIND ENERGY INSTALLATION AND METHOD FOR CONTROLLING A COOLING OF A WIND ENERGY INSTALLATION

(71) Applicant: Wobben Properties GmbH, Aurich (DE)

(72) Inventors: Jan DE VRIES, Aurich (DE); Kai ENSKONATUS, Hinte (DE); Malte KÖNITZ, Oldenburg (DE)

(21) Appl. No.: 15/755,508

(22) PCT Filed: Aug. 31, 2016
(86) PCT No.: PCT/EP2016/070502

§ 371 Date: Feb. 26, 2018

(30) Foreign Application Priority Data
Sep. 4, 2015 (DE) 10 2015 217 035.7

(51) Int. Cl. F03D 13/20; F03D 80/60

(52) U.S. Cl. CPC F03D 13/22; F05B 2260/201; F03D 80/60

(57) ABSTRACT

A wind power installation in which conduits through which a cooling medium flows are passed from the interior of the wind power installation through the tower wall or through the foundation outwardly, and the cooling conduits in the heat exchanger bear externally against the tower or are arranged there and are arranged between the tower wall and a cover of the wall of the cooling system.

### BACKGROUND

### Technical Field

The present invention concerns a wind power installation and a method of controlling a cooling of a wind power installation.

### Description of the Related Art

In the conversion of energy in a wind power installation losses regularly occur in the form of heat. That applies both in regard to the conversion of the kinetic energy of the wind into electrical energy in the generator of a wind power installation, in which case those losses regularly occur in the main drive train of the wind power installation, and also in the electrical feed of the energy generated by the wind power installation into a grid, for example a medium voltage grid. Power electronic apparatuses, for example inverters, transformers and/or switching installations or the like are usually required for that purpose.

In the main drive train which in a wind power installation is disposed in the pod of the wind power installation the losses crucially occur in the transmission (if such is provided), at the bearings, in the generator (for example the hysteresis losses) or at other control units, like for example at the hydraulic installations or open-loop or closed-loop control units, for example pitch drives, by means of which the rotor blades are set, or yaw drives, by means of which the wind power installation is set in relation to the wind. If moreover power electronic apparatuses like for example transformers, rectifiers and/or the like are disposed in the pod of the wind power installation then heat is also produced in such units in operation of the wind power installation, and has to be dissipated.

In the case of gear-less wind power installations the main losses occur in the main drive train in the generator, that is to say in the pod of the wind power installation on the one hand and in the grid transformer and possibly in the power electronics, for example inverters, wherein the latter are usually disposed in the region of the base of the tower of the wind power installation. In the case of a 1.5 MW wind power installation the losses can be in the range of 50 kW to 100 kW.

EP 1 200 733 discloses a wind power installation having a closed cooling circuit, wherein the tower of the wind power installation is incorporated as a cooling element or as a heat exchange means into the cooling circuit and heat which is produced in the interior of the wind power installation is discharged by way of the tower of the wind power installation. The advantage of that structure is that the desired cooling effect can be achieved with as little external air as possible so that the ingress of moisture, dust or other constituents from the air (for example including salt) is prevented to the best possible degree, or at any event is reduced markedly in comparison with other structures. If however it is not possible to provide for sufficient cooling of the components within the wind power installation then under some circumstances it is necessary to have recourse to a feed of extraneous air from the exterior to improve the cooling efficiency. That can involve problems with dust or salt or the like.

DE 10 2004 061 391 discloses a wind power installation in which a conduit for a heat medium extends at least portion-wise through the foundation of the wind power installation and is suitable for exchanging heat with the ground, in that case the conduit is also to extend at least portion-wise through the earth itself.

EP 2 002 120 discloses a heat management system for a wind power installation, wherein the heat-generating components (transformers, converters and so forth) are arranged directly on the inside surface of the tower of the wind power installation and the heat generated by the heat-generating components is dissipated directly to the inside surface of the tower of the wind power installation, thereby providing a good heat conduction route to the entire wind power installation tower.

DE 10 2009 055 784 discloses a wind power installation and a method of temperature regulation by means of a component of a wind power installation, wherein temperature regulation includes at least one thermally insulated fluid storage means and a conduit system connecting the fluid storage means with at least one component to the wind power installation and a device for transporting a fluid through the conduit system, wherein the at least one component and the conduit system are in thermal relationship with each other. The fluid storage means is disposed outside the tower of the wind power installation.

EP 1 798 414 discloses a wind power installation in which heat exchangers in the form of cooling ribs are arranged externally on the tower, which are passed with a heat-conducting medium (for example air or water) through the tower wall and that medium is heated by the components of the wind power installation within the wind power installation so that the heated medium is passed to the outside of the tower in order there to be cooled down by means of the heat exchangers. The heat exchangers are arranged at at least four sides of the tower of the wind power installation in order thereby always to provide for optimum cooling irrespective of the wind direction.

EP 2 203 642 discloses a wind power installation in which the heat which occurs within the tower of the wind power installation is dissipated by a heat exchanger and a conduit system connected thereto by way of a heat-carrier medium, more specifically through the foundation of the wind power installation into a further heat exchanger which is disposed outside and beside the tower.

Further cooling concepts for wind power installations are also known, for example WO-A-99/30031, DE-A-19528862, DE 2707343, DE 69217654, JP 60-245955, JP 60-93261, DE-A1-10 352023, WO-A-01/77526, US-B1-7168251 and DE-A1-10 2004061391.

Some of the solutions which are already previously known are also in part highly cost-intensive (for example those known from DE 10 2004 061 391 or EP 2 203 642) and the solutions known from DE 10 2009 055784 are also not suitable for offshore use.

Finally many of the previously known solutions are extremely maintenance-intensive, which in turn increases the costs of the system. Moreover most of the previously known solutions cannot be retro-fitted in an existing installation and some solutions, for example that known from EP 1 798 414, are not secure from vandalism, that is to say deliberate destruction of the cooling ribs disposed at the outside wall of the tower.

In particular the solutions known from EP 1 798 414, DE 10 2009 055784, EP 2 002 120 or DE 10 2004 061 391 do not comply with the requirement for attractive aesthetics in respect of the entire wind power installation.

On the German patent application from which priority is claimed the German Patent and Trade Mark Office searched the following documents: DE 199 32 394 A1, US 2012/0 119 505 A1 and EP 2 000 668 A1.

### BRIEF SUMMARY

Provided is cooling system for a wind power installation which further affords an aesthetically attractive appearance, which is low in maintenance, which is very substantially safe from vandalism damage, which can also be retro-fitted, which is moreover inexpensive and which also affords an improved cooling performance.

Advantageous developments are described in the appendant claims.

Thus there is proposed a wind power installation having a first cooling unit, in which conduits through which a cooling medium flows are passed from the interior of the wind power installation through the tower wall or through the foundation outwardly, and the cooling conduits in the heat exchanger bear externally against the tower or are arranged there and are arranged between the tower wall and a cover of the wall of the cooling system.

The advantage of this solution is that the first cooling unit can be provided in the region of the foundation, that is to say in the region of the tower that is near the ground, for example at a tower segment, near to the foundation, of the wind power installation, and the overall aesthetics of the wind power installation are not seriously adversely affected by the cover, the solution can be retro-fitted in particular in an existing wind power installation (which therefore is already in operation), the solution is also very substantially vandalism-proof and is also easy to maintain.

Preferably provided in the region between the tower wall (outward side) and the cover (inward side) of the cooling system is a ventilation system, for example comprising a plurality of fans, in order in that way to draw cooling air from the exterior through an opening for example in the lower region, to push it into the space between the tower wall and the cover in order thereby to flow around the cooling conduits disposed there in the heat exchangers and to cool down the cooling medium which is in the cooling conduits.

If the cover or wall of the cooling system in the region of the tower base is visually matched to the exterior of the tower overall, for example by coloring, the entire cover or wall is also scarcely perceptible and therefore scarcely or does not at all adversely affect the aesthetics of the overall wind power installation. The cooling system is moreover very substantially safe in relation to vandalism by virtue of the cover or wall, that applies in particular when the cover or wall comprises a metal plate or the like, and in particular the cooling system can be retro-fitted at any time. In addition the cooling system is extremely low-maintenance and the solution is thus very inexpensive.

In the region near the tower the towers of wind power installations usually have one, two or more doors. If now such a wind power installation is equipped with a cooling system and the cover or wall thereof at the region near the base of the tower access to the towers must obviously be possible at any time, and therefore the cooling conduit or the like should not cover over the door surface. On the other hand it is also possible to provide in front of the actual door which is in the tower itself, a second door which is then provided in the cover so that two doors need to be opened for access to the wind power installation. That even further structurally increases the security of the wind power installation in relation to criminal access and unauthorized entry to the wind power installation.

In that respect the door which is in the cover or wall and which is opposite to the door in the tower wall can also be so equipped that it has a different lock-key system from the door in the tower of the wind power installation. In addition the door in the cover can be provided with an alarm system so that, if anyone intrusively breaks open that door an alarm is automatically triggered and the unauthorized person then still has to open the door in the tower wall, which requires a certain amount of time, and thus permits the service personnel (or police) and the like to get to the wind power installation in good time and restore the security of the wind power installation.

It is particularly preferred in that respect that the door which is provided in the cover or wall is in the form of a sliding door, wherein the door leaf at its front end lies behind the cover when the door is closed and cannot thus be pushed to the side even with a burglary tool.

The door in the cover or wall further enhances the aesthetically unitary impression of the overall wind power installation.

In a preferred (also alternative) embodiment the cooling conduits themselves can also be passed into the foundation of the wind power installation so that heat which is discharged by the cooling medium is discharged into the foundation of the installation.

It is also possible for a recooler or heat exchanger which is disposed in the tower foundation to be linked to the cooling conduit.

The cooling apparatus in this embodiment also has the advantage that the discharge of heat in the region of the tower base means that this region of the tower, even when it is extremely cold outside, for example −30° C., is always still at a markedly higher temperature—in relation to the outside temperature—and thus any equipment within the tower is better protected from frost or rust damage, cold, air humidity or the like.

It has also already happened before that a cold weather period is preceded by intensive rain hitting the installation and that water also beat against the doors in the tower wall due to the rain running off/dripping from the tower and then froze there. In such a situation it is extremely difficult for the service personnel to open such doors at all, because of the icing. By means of the invention it is now also ensured that such icing at the doors does not occur in the first place and thus access to the installation is guaranteed.

In the variant described above the cooling means forms the sole cooling device of the wind power installation.

### BRIEF DESCRIPTION OF THE SEVERAL VIEWS OF THE DRAWINGS

FIG. 1 shows a diagrammatic view of a wind power installation according to the invention,

FIG. 2 shows a diagrammatic view of a lower region of a tower of a wind power installation according to a first embodiment,

FIG. 3 shows a diagrammatic partial section of a tower of a wind power installation according to the first embodiment,

FIG. 4 shows a diagrammatic view of a cooling unit of a wind power installation according to a second embodiment,

FIG. 5 shows a sectional view of a lower region of a tower of a wind power installation according to a first or a second embodiment,

FIG. 6 shows a diagrammatic sectional view of a lower region of a tower of a wind power installation according to the first or second embodiment,

FIG. 7 shows a diagrammatic sectional view of a wind power installation according to a third embodiment, and

FIG. 8 shows a diagrammatic sectional view of a wind power installation according to a fourth embodiment.

### DETAILED DESCRIPTION

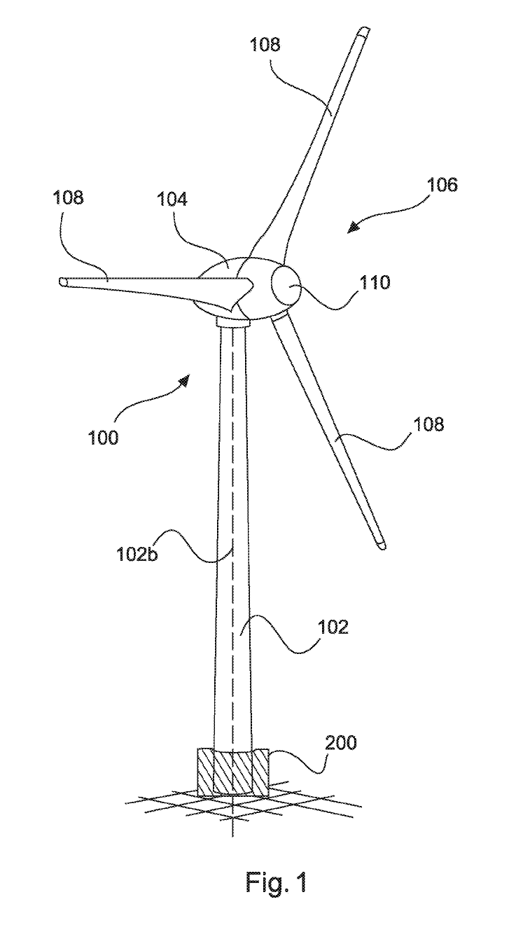

FIG. 1 shows a diagrammatic view of a wind power installation according to the invention. The wind power installation 100 has a tower 102 having a longitudinal axis 102b and a pod 104 on the tower 102. The tower 102 can have a plurality of tower segments which are placed one upon the other to constitute the tower 102. Provided at the pod 104 is an aerodynamic rotor 106 with for example three rotor blades 108 and a spinner 101. The aerodynamic rotor 106 is caused to rotate by the wind in operation of the wind power installation and thus also rotates a rotor member of an electric generator which is directly or indirectly coupled to the aerodynamic rotor 106. The electric generator is arranged in the pod 104 and generates electrical energy. The pitch angle of the rotor blades 108 can be changed by pitch motors at the rotor blade roots of the respective rotor blades 108.

A first cooling unit 200 is provided in the region of a lower tower segment. In this case the first cooling unit 200 is provided externally at the lower or around the lower tower segment or the tower base.

The cooling unit can be in the form of a continuous ring or alternatively also not continuous, but segment-wise, for example in the form of a half-segment, quarter-segment, eighth-segment and so forth around the tower of the wind power installation.

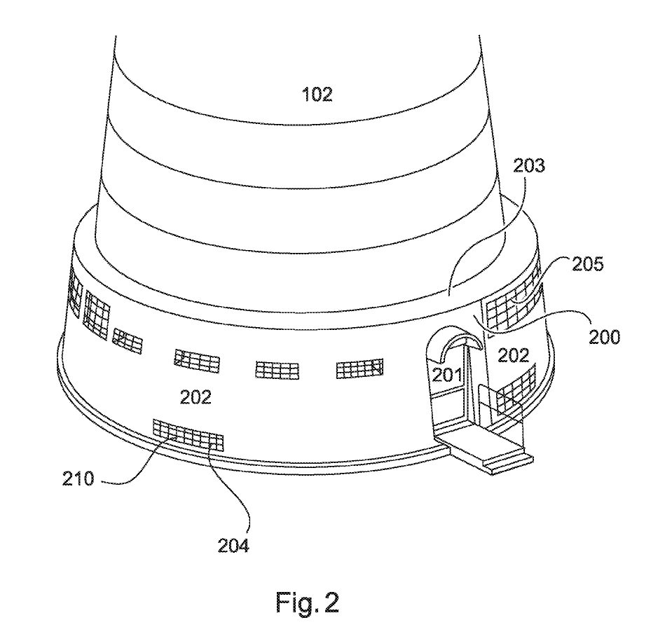

FIG. 2 shows a diagrammatic view of a lower region of a tower of a wind power installation according to a first embodiment. The first cooling unit 200 has a wall 202 and a roof 203 and preferably completely surrounds the tower 102. As an alternative thereto however the first cooling unit 200 may also only partially surround the tower 102. The first cooling unit 200 has a plurality of lower openings 204 and a plurality of upper openings 205 in the wall 202. The upper openings can also be provided in the roof 203 of the first cooling unit. The first cooling unit also has at least one door 201.

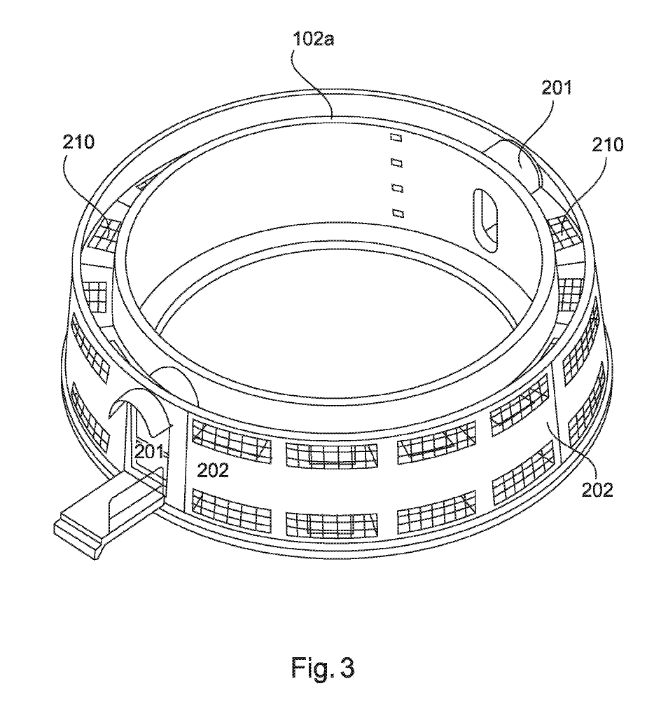

FIG. 3 shows a diagrammatic partial section of a tower of a wind power installation according to the first embodiment. The first cooling unit 200 has a wall 202 having a plurality of lower openings 204 and a plurality of upper openings 205. The wall 202 is at a spacing relative to the wall 102a of the tower 102. A plurality of heat exchangers 210 is provided between the tower wall 102a and the wall 202 of the first cooling unit 200. The heat exchangers 210 can have for example a cooling conduit or a plurality of cooling conduits. Optionally the heat exchangers 210 can be arranged perpendicularly to the longitudinal direction 102b of the tower 201.

Cool air can be sucked in through the lower openings 204, guided past the heat exchangers 210, and the heated air can then be discharged outwardly by way of the upper openings 205.

A cooling agent can be present in the heat exchangers 210, the cooling agent being passed through the tower wall 102a to cool the components of the wind power installation.

In particular the heat exchangers 210 can have a heat exchanger surface 211 which represents the active heat-exchanging surface 211. The heat-exchanging surface 211 can have for example a plurality of walls of the cooling conduits so that the cool air flowing through the heat-exchanging surface 211 cools the cooling agent in the cooling conduits.

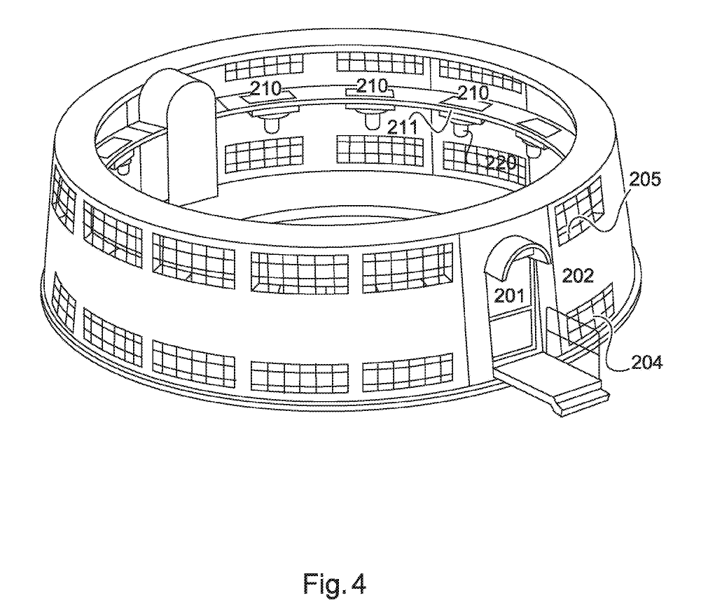

FIG. 4 shows a diagrammatic view of a first cooling unit of a wind power installation according to a second embodiment. FIG. 4 in particular shows only the first cooling unit 200. The first cooling unit 200 has a wall 202, a plurality of lower openings 204, a plurality of upper openings 205 and a plurality of heat exchangers 210. Optionally fans 220 can be respectively arranged under the heat exchangers 210. Accordingly cool air can be sucked in by the fans 220 by way of the lower openings 204, guided past the heat exchanger 210 (being heated there) and discharged by way of the upper openings 205. A cooling agent in the heat exchangers 210 can be cooled by that air flow.

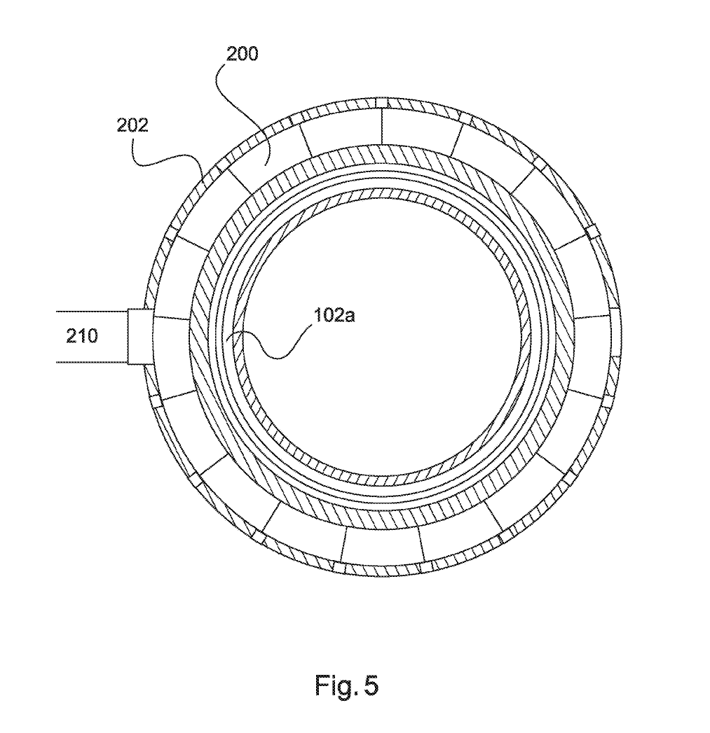

FIG. 5 shows a cross-section of a lower region of a tower of the wind power installation. The wall 202 of the first cooling unit 200 is disposed at a spacing relative to the wall 102a of the tower segment 102. A plurality of heat exchangers 210 can be provided in the region between the tower wall 102a and the wall 202 of the first cooling unit 200.

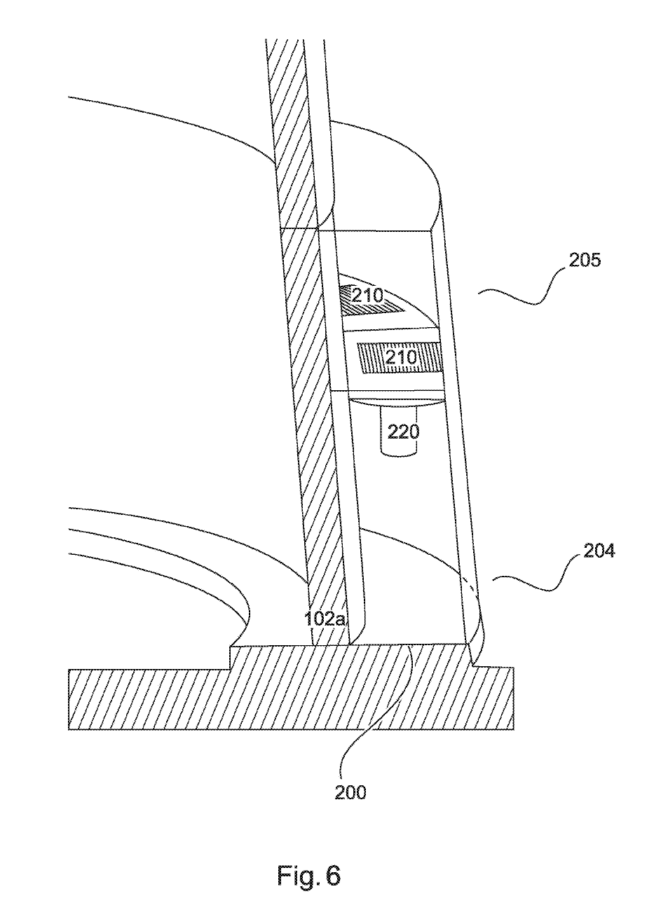

FIG. 6 shows a diagrammatic sectional view of a lower region of a tower of a wind power installation according to the first or second embodiment. The first cooling unit 200 has a wall 202 at a spacing relative to the tower wall 102a, a plurality of lower openings 204 and a plurality of upper openings 205. A plurality of heat exchangers 210 is provided between the tower wall 102a and the wall 202 of the first cooling unit 200, for example being arranged perpendicularly to the longitudinal axis of the tower. Optionally a fan 220 can be provided beneath each heat exchanger 210.

In an alternative embodiment the first cooling unit 200 does not have any ventilators or fans 220 but at least one pump to convey a cooling agent through the heat exchangers 210.

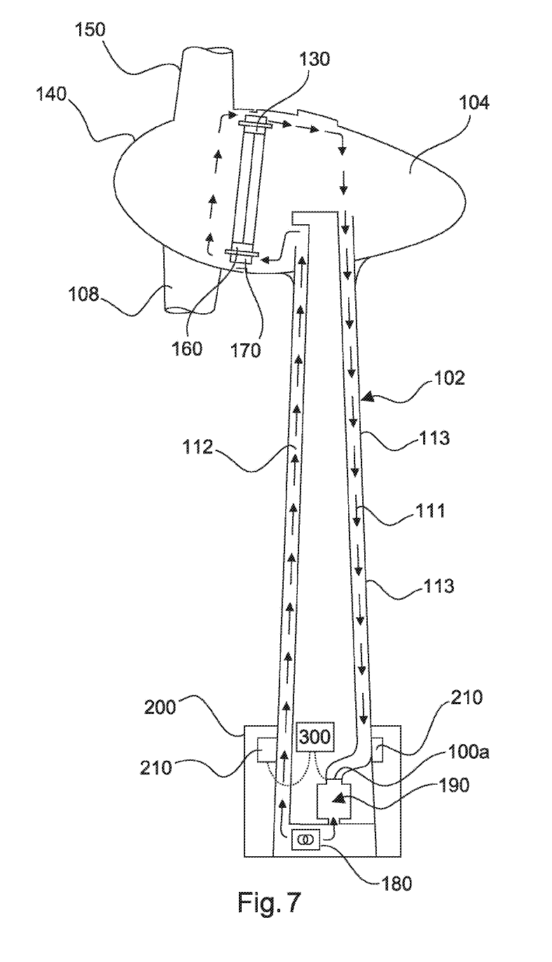

FIG. 7 shows a diagrammatic sectional view of a wind power installation according to a third embodiment. FIG. 7 shows a wind power installation as is described in EP 1 200 733. In addition thereto provided in the lower region of the tower is a first cooling unit 200 according to the first or second embodiment. The wind power installation of the third embodiment thus has two cooling systems or cooling units. FIG. 7 shows a cross-section through a wind power installation having a pod 104 at the head end of a tower 102. The pod 104 can accommodate a main drive train of the wind power installation. That main drive train substantially comprises an aerodynamic rotor 106 and rotor blades 108 mounted thereto. The aerodynamic rotor 106 is connected to a generator 130 which has a generator rotor member 160 and a generator stator 170. When the aerodynamic rotor 106 and therewith the generator rotor member 160 rotate electrical energy, for example in the form of ac current or dc current, is generated. A transformer 180 and a power cabinet 190 having an inverter can be provided in the lower region of the tower 102.

In addition the wind power installation has a second cooling unit which for example in the lower region of the tower 102 has at least one fan 100a which can drive air from the region of the transformer 180 and the power cabinet or inverter 190 through a passage 112 along the wall of the tower 102 upwardly into the pod 104. There the air flow flows through or past the generator 130 and flows downwardly again along the wall 102a of the tower 102. Thus the air is cooled and a closed cooling circuit is obtained, which is highly advantageous in particular in the offshore region because in that way no external air or only greatly limited external air can enter. The cooling passages 112, 111 can be in the form of hoses or conduits. As an alternative thereto the wall of the tower 102 can be of a double-wall structure. Because the heated air flows upwardly from the lower region of the tower 102 through the passage 111 and thus flows past the wall of the tower 102 the wall of the tower 102 acts as a heat exchanger so that the air is cooled down within the passages.

Optionally the power cabinet 190 and a transformer 180 can be cooled by the air flow through the cooling passages 111, 112 of the second cooling unit.

As already described above a cooling unit 200 is additionally provided in the lower region of the tower 102.

Thus the wind power installation of the third embodiment has a cooling system comprising two cooling units. The second cooling unit is provided by the passages 111, 112 at the wall of the tower 102 and by the fan 100a. The first cooling unit 200 corresponds to the cooling unit of the first or second embodiment.

In the case of a combination of both cooling units, each of the cooling units can then be controlled in such a way as to achieve optimum cooling of the wind power installation on the one hand and also optimum operation of the individual cooling units on the other hand.

The wind power installation of the third embodiment has a cooling control unit 300. The cooling control unit 300 is coupled both to the first cooling unit 200, 210 and also to the second cooling unit (fan 100a). The control unit 300 can also receive operating parameters of the wind power installation like for example the temperature of the generator, a temperature of the transformer, a temperature of the power cabinet, an outside temperature and so forth, and appropriately control operation of the first and second cooling units. In a first mode of operation of the cooling control unit 300 only the second cooling unit is controlled, by controlling the speed of rotation of the fan 100a. The first cooling unit 200 can be deactivated in that case. In a second mode of operation only the first cooling unit 200 is activated but not the second cooling unit 100a. In a third mode of operation both the first and also the second cooling units 100a, 200 are activated. The cooling control unit 300 is adapted to control operation of the first and second cooling units 100a, 200 in such a way as to achieve optimum cooling, having regard to the cooling properties of the first and second cooling units.

Thus according to an aspect of the invention it is possible that it is not both cooling units that always and constantly contribute to cooling the overall assemblies of the wind power installation to the same individually and maximum possible extent, but that when a first cooling effect for the wind power installation is required, firstly the first cooling unit in accordance with the first or second embodiment is operated and that with a further increase in the demand for cooling the second cooling unit in the interior of the tower, that is to say with the closed cooling circuit, is switched on.

It will be appreciated that it is also possible for the individual systems to be switched on in precisely the reverse fashion, therefore for example in the low part-load range of the wind power installation, firstly operation is to be implemented only with the first cooling unit of FIG. 7, and it is only when there is a higher demand for cooling that the second cooling unit is added.

Switching-on of the individual cooling units can be controlled in target-oriented fashion by means of the control unit 300 and the respective proportion of cooling of the individual cooling units can be adjusted in target-oriented fashion in order thereby to provide for optimum cooling of the components in the wind power installation on the one hand, and on the other hand to operate overall cooling of the wind power installation with the lowest possible level of energy expenditure.

Finally it is preferably also possible for the closed cooling circuit arranged in the interior of the tower of the wind power installation to be connected into the cooling circuit provided at the outside wall of the tower wall but within the cover.

A gas, for example air, but also liquid, for example water, oil or the like can be used as the cooling medium.

When using a gas as the cooling medium it is provided by means of a fan device that the cooling medium is moved through the conduits/pipes. When using a liquid cooling medium forced convection is implemented by means of a pump or a plurality of pumps.

The fans on the one hand and/or the pumps on the other hand are in that case controlled by the control unit 300 and connected thereto.

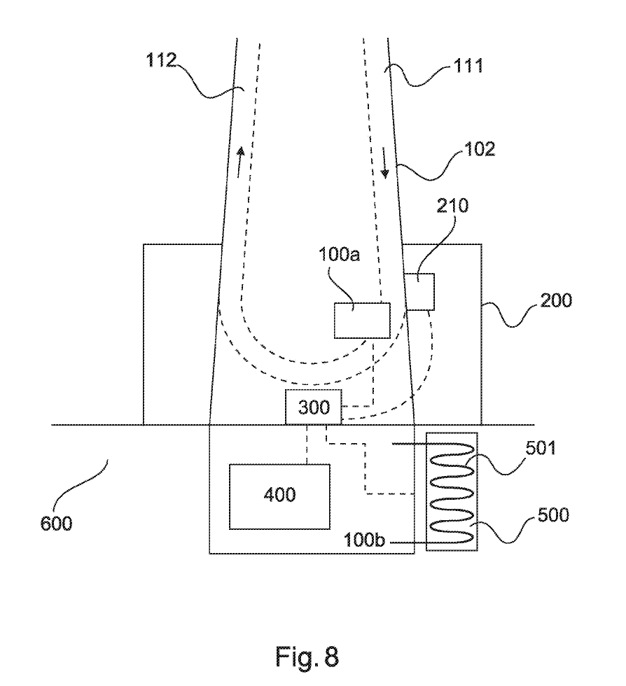

FIG. 8 shows a diagrammatic sectional view of a wind power installation according to a fourth embodiment. FIG. 8 shows in particular only a lower part of the wind power installation and the foundation thereof. The wind power installation has a tower 102 and a foundation 600. A first cooling unit 200 according to the first or second embodiment is provided around the lower region of the tower. Provided in the interior of the tower of the wind power installation is at least one fan 101 as well as cooling passages 111, 112 which provide a second cooling unit according to the third embodiment shown in FIG. 7. Optionally a third cooling unit like for example a heat storage means 400 can be provided in a cellar 100b beneath the tower 102. That heat storage means 400 can represent for example a water tank of for example 20 m³ or more. The heat storage means 400 thus represents a third cooling unit and can be connected to the first and/or second cooling unit 200, 100a. As in the third embodiment there is provided a cooling control unit 300 which can be coupled to the first, second and/or third cooling unit and can control operation of the respective cooling units.

In addition thereto a fourth cooling unit 500 can optionally be provided in the foundation 600 of the wind power installation. The fourth cooling unit 500 can be in the form of a heat exchanger with cooling passages 501 in the foundation 600. The fourth cooling unit 500 can be coupled to the first, second and/or third cooling unit.

The wind power installation can have a concrete tower or a steel tower or a combination thereof.

Air conditioning or climate control of the cellar 100b can be made possible with the heat storage means 400 or the third cooling unit 400 in the cellar 100b. That is advantageous if for example clamping anchors are provided for example in the case of a concrete tower in the cellar 100b. Accordingly rusting of the anchors can be at least reduced by operation of the third cooling unit 400.

Optionally the transformer 180 and/or the power cabinet 190 with the power electronics as shown in FIG. 7 can be provided in the cellar 100b. Operation of the third cooling unit 400, namely the heat storage means 400, can thus be controlled by the control unit 300 in such a way that the power cabinet 190 and/or the transformer 180 in the cellar 100b are cooled or the cellar 100b can be air-conditioned or climate-controlled by operation of the third cooling unit 400. In regard to control of the first, second, third or fourth cooling unit the control unit 300 can optionally detect the temperature in the cellar 100b, in the foundation 600 and outside the tower 102 and take that into account in its control.

1. A wind power installation comprising:
a foundation;
a tower having a tower wall and a longitudinal axis on the foundation;
a first cooling unit in a lower region of the tower having a plurality of heat exchangers; and
an outer wall spaced from the lower region of the tower wall by an intermediate space,
wherein the plurality of heat exchangers are arranged in the intermediate space between the tower wall and the outer wall of the first cooling unit,
wherein the first cooling unit has a plurality of lower openings beneath the plurality of heat exchangers and a plurality of upper openings above the plurality of heat exchangers, and
wherein the first cooling unit has a roof extending between the tower wall and the outer wall of the cooling unit and covers the intermediate space,
wherein the first cooling unit has at least one cooling conduit that extends through at least one of the tower wall or the foundation, wherein a cooling medium flows through the at least one cooling conduit, and
wherein the first cooling unit has at least one fan configured to draw in air through the lower openings and passes the air through the heat exchangers so that the air is provided through the upper openings.

2. The wind power installation according to claim 1 wherein the plurality of heat exchangers are arranged substantially perpendicularly or horizontally relative to the longitudinal axis of the tower of the wind power installation.

3. (canceled)

4. The wind power installation according to claim 1 further comprising:
a second control unit in an interior of the tower, the second control unit having at least one fan and at least one cooling passage in at least one of the tower wall or the foundation,
wherein the fan is adapted to cause air to flow along the at least one cooling passage along at least one of the tower wall and/or or the foundation for cooling purposes.

5. The wind power installation according to claim 1 and further comprising:
a third cooling unit in the cellar, and
a cooling control unit adapted to control at least one of the first, second or third cooling unit.

6. The wind power installation according to claim 4, further comprising:
a fourth cooling unit in the foundation of the wind power installation,
wherein the fourth cooling unit has at least one cooling passage in the foundation, and
wherein the control unit is adapted to control operation of at least one of the first, second, third or fourth control unit.

7. A retro-fittable cooling unit for a wind power installation which has a tower with a tower wall, comprising
a roof,
an outer wall having a plurality of lower and upper openings, and
a plurality of heat exchangers within the outer wall and between the lower and upper openings,
wherein the cooling unit is configured to be arranged around the tower wall,
wherein the cooling unit has at least one cooling conduit configured to extend through at least one of the tower wall or a foundation, wherein a cooling medium is configured to flow through the cooling unit, and
wherein the cooling unit has at least one fan configured to draw in air through the lower openings and passes the air through the heat exchangers so that the air passes through the upper openings.

8. A method comprising:
controlling cooling of a wind power installation, the wind power installation including a tower having a tower wall and a longitudinal axis, wherein the wind power installation has a first cooling unit in a lower region of the tower and externally to the tower, the first cooling unit including a plurality of heat exchangers, the wind power installation having a second cooling unit in an interior of the tower, third cooling unit in a cellar of the wind power installation, and a fourth cooling unit in a foundation of the wind power installation, wherein controlling comprises:
controlling operation of the first, second, third and fourth cooling units using a cooling control unit,
wherein in a first mode of operation one of first, second, third, and fourth cooling units is activated while other of the first, second, third and fourth cooling units are deactivated,
wherein in a second mode of operation two of the first, second, third, and fourth cooling units are activated while the two of the first, second, third, and fourth cooling units are deactivated,
wherein in a third mode of operation three of the first, second, third, and fourth cooling units are activated, and
wherein in a fourth mode of operation each of the first, second, third, and fourth cooling units are activated.

9. The wind power installation according to claim 2, wherein surfaces of the plurality of heat exchangers are arranged substantially perpendicularly or horizontally relative to the longitudinal axis of the tower of the wind power installation.

10. The wind power installation according to claim 5, wherein the third cooling unit is a heat storage means.
